(19) United States
(12) Patent Application Publication
(10) Pub. No.: US 2026/0220184 A1
(43) Pub. Date: Jul. 30, 2026

(54) TEXT-CONTENT SELECTION FOR DIGITAL CONTENT COLLECTIONS

(71) Applicant: GOOGLE LLC, Mountain View, CA (US)

(72) Inventors: Rishav Anand, Cupertino, CA (US); Patricio Andres Saldivar Flores, San Francisco, CA (US)

(21) Appl. No.: 19/040,473

(22) Filed: Jan. 29, 2025

(51) Int. Cl. G06F 16/355; G06F 16/3329; G06F 40/30

(52) U.S. Cl. CPC G06F 16/355; G06F 16/3329; G06F 40/30

(57) ABSTRACT

A method for text asset selection includes determining preferred text-content pairs based at least in part on predicted performance outcomes for a plurality of text-content pairs. The method also includes obtaining a plurality of content items from a digital content collection; obtaining a plurality of text assets; generating a plurality of sample text-content pairs; determining performance outcomes for the plurality of sample text-content pairs; generating a text asset performance model based on the performance outcomes for the plurality of sample text-content pairs; applying the text asset performance model to each target text-content pair of a plurality of target text content pairs to generate predicted performance outcomes for the plurality target text-content pairs; determining one or more preferred text-content pairs based at least in part on the predicted performance outcomes for the plurality of target text-content pairs; and providing the one or more preferred text-content pairs to one or more devices.

### FIELD OF TECHNOLOGY

The present disclosure relates to text assets and collections of digital content, and in particular relates to techniques for improving text asset selection for content items in a digital content collection.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

Matching digital content such as videos and images to text assets (e.g., textual descriptions, headlines, metadata) poses significant challenges to content providers. In the realm of in-video (e.g., mid-roll) advertising, for example, text descriptions are often presented with a content item and can impact the overall performance of the content item. Digital content collections can be quite large, and may include many content items and/or many text assets. Thus, it can be difficult to accurately and efficiently determine which combinations of content items and text assets will provide the best performance according to a desired metric (e.g., impression rate, conversion rate, and/or another performance metric)

### SUMMARY

The disclosed techniques improve text asset selection/matching for content items in a digital content collection by generating a text asset performance model based on performance outcomes for sampled text asset and content item pairs (referred to herein as “text-content pairs”). As the terms are used herein, a “text asset” can refer to any textual information (e.g., text descriptions, titles, metadata, etc.) and a “content item” can refer to any digital content item (e.g., image, video, etc.). The “performance outcome” of providing a particular text-content pair may be a user interaction with (e.g., impression of, or selection of) the text-content pair, and the performance outcome of providing a number of text-content pairs may be a statistical measure of such user interactions (e.g., an impression rate or likelihood), for example.

As mentioned above, digital content collections may include a corpus of many content items and/or text assets. Advantageously, the disclosed techniques enhance efficiency by leveraging a relatively small subset (e.g., a randomly sampled subset) of the text-content pairs available in a digital content collection to generate a text asset performance model capable of accurately predicting the highest performing text-asset pairs. In particular, the disclosed techniques can conduct an exploration phase by applying the sampled subset of text-content pairs in real-world operation and observing the resulting performance outcomes (e.g., impressions or impression rates, click-throughs or click-through rates, etc.). The disclosed techniques can then generate the text asset performance model based on these observed results, after which the model predictions can enable the intelligent selection of text assets that are more likely to enhance performance of content items within the digital content collection. Such an approach not only improves the overall effectiveness of digital content collections, but also improves the efficiency and interpretability of the content item and text asset pairing/selection process. In some implementations, the disclosed techniques can run automatically as backend operations on a persistent (e.g., periodic) basis in order to continuously improve the performance of a digital content collection by producing continuously evolving text-content pairings.

Often, content curation techniques either (1) do not vary text assets provided with a content item (e.g., a content item has only one corresponding text asset) or (2) employ a heuristic approach when determining which text asset to provide with a content item (e.g., select a text asset with the highest grade or score, and/or provide a text asset in a particular language). However, predicting text-content pairs that are likely to produce good performance metrics (e.g., impression rates, click-through rates, conversion rates, etc.) poses significant challenges using such techniques. For example, a text-content pair may include a digital content item (e.g., a video and/or one or more images) and a text asset that individually have low performance, but synergistically combine so as to provide high performance. More specifically, individual measurable performance of a particular text asset and/or content item may be based on the collective performance of text-content pairs that include the particular text asset and/or content item. Expanding on this example, the text asset may individually have low performance because the text asset is unusually short (e.g., as compared to the average number of characters for a text asset in the collection), but the text-content pair has high performance because the brevity of the text asset is beneficial in the context of the content item. As a counter example, a text asset may include a digital content item and a test asset that individually have high performance, but combine so as to provide low performance. Notably, the disclosed techniques (e.g., in connection with FIGS. 1, 2, 3, and 4) can identify preferrable text-content pairs of a digital content collection that are likely to have high performance (e.g., with respect to impression rate, click-through rate, conversion rate, etc.) using a text asset performance model generated, at least in part, based on real-world performance outcomes collected in an exploration phase for a subset of text-content pairs sampled from the digital content collection.

In some implementations, the text asset performance model is a probabilistic (e.g., Bayesian) model. Such a model enables the efficient prediction of text-content pair performance with relatively low consumption of processing resources, e.g., as compared to neural networks.

In other implementations, the text asset performance model is a deep neural network (DNN) or a multi-task unified model (MUM). Such a model can better filter out noise from data and can better generalize to new/unseen data, as compared to a probabilistic model which is more likely to be influenced by irrelevant or inaccurate information and less likely to perform well in the presence of new situations/data patterns.

Other advantages will also become apparent to one of ordinary skill in the art upon reading this disclosure and viewing the corresponding drawings.

In one aspect, a method for text asset selection includes: (1) obtaining, by one or more processors, a plurality of content items from a digital content collection associated with a content item group; (2) obtaining, by the one or more processors, a plurality of text assets associated with the content item group; (3) generating, by the one or more processors, a plurality of sample text-content pairs consisting of a subset of the possible combinations of the plurality of text assets and the plurality content items; (4) determining, by the one or more processors, performance outcomes for the plurality of sample text-content pairs; (5) generating, by the one or more processors, a text asset performance model based on the performance outcomes for the plurality of sample text-content pairs; (6) applying, by the one or more processors, the text asset performance model to each target text-content pair of a plurality of target text content pairs to generate predicted performance outcomes for the plurality target text-content pairs, with each target text-content pair including (i) a respective content item of the plurality of content items and (ii) a respective text asset of the plurality of text assets; (7) determining, by the one or more processors, one or more preferred text-content pairs, from among the plurality of target text-content pairs, based at least in part on the predicted performance outcomes for the plurality of target text-content pairs; and (8) providing, by the one or more processors, the one or more preferred text-content pairs to one or more user devices.

In another aspect, a system includes one or more processors and one or more memories storing instructions that, when executed by the one or more processors, cause the one or more processors to: (1) obtain a plurality of content items from a digital content collection associated with a content item group; (2) obtain a plurality of text assets associated with the content item group; (3) generate a plurality of sample text-content pairs consisting of a subset of the possible combinations of the plurality of text assets and the plurality content items; (4) determine performance outcomes for the plurality of sample text-content pairs; (5) generate a text asset performance model based on the performance outcomes for the plurality of sample text-content pairs; (6) apply the text asset performance model to each target text-content pair of a plurality of target text content pairs to generate predicted performance outcomes for the plurality target text-content pairs, with each target text-content pair including (i) a respective content item of the plurality of content items and (ii) a respective text asset of the plurality of text assets; (7) determine one or more preferred text-content pairs, from among the plurality of target text-content pairs, based at least in part on the predicted performance outcomes for the plurality of target text-content pairs; and (8) provide the one or more preferred text-content pairs to one or more user devices.

In another aspect, one or more non-transitory, computer-readable media store instructions that, when executed by one or more processors, cause the one or more processors to: (1) obtain a plurality of content items from a digital content collection associated with a content item group; (2) obtain a plurality of text assets associated with the content item group; (3) generate a plurality of sample text-content pairs consisting of a subset of the possible combinations of the plurality of text assets and the plurality content items; (4) determine performance outcomes for the plurality of sample text-content pairs; (5) generate a text asset performance model based on the performance outcomes for the plurality of sample text-content pairs; (6) apply the text asset performance model to each target text-content pair of a plurality of target text content pairs to generate predicted performance outcomes for the plurality target text-content pairs, with each target text-content pair including (i) a respective content item of the plurality of content items and (ii) a respective text asset of the plurality of text assets; (7) determine one or more preferred text-content pairs, from among the plurality of target text-content pairs, based at least in part on the predicted performance outcomes for the plurality of target text-content pairs; and (8) provide the one or more preferred text-content pairs to one or more user devices.

### BRIEF DESCRIPTION OF THE DRAWINGS

FIG. 1 is a block diagram of an example system in which techniques for text asset selection can be implemented.

FIG. 2 is a block diagram of a process for improved text asset selection for content items in a content collection.

FIG. 3 is a block diagram of a deep neural network for improved text asset selection for content items in a content collection.

FIG. 4 is a flow diagram of an example method for text asset selection.

### DETAILED DESCRIPTION OF THE DRAWINGS

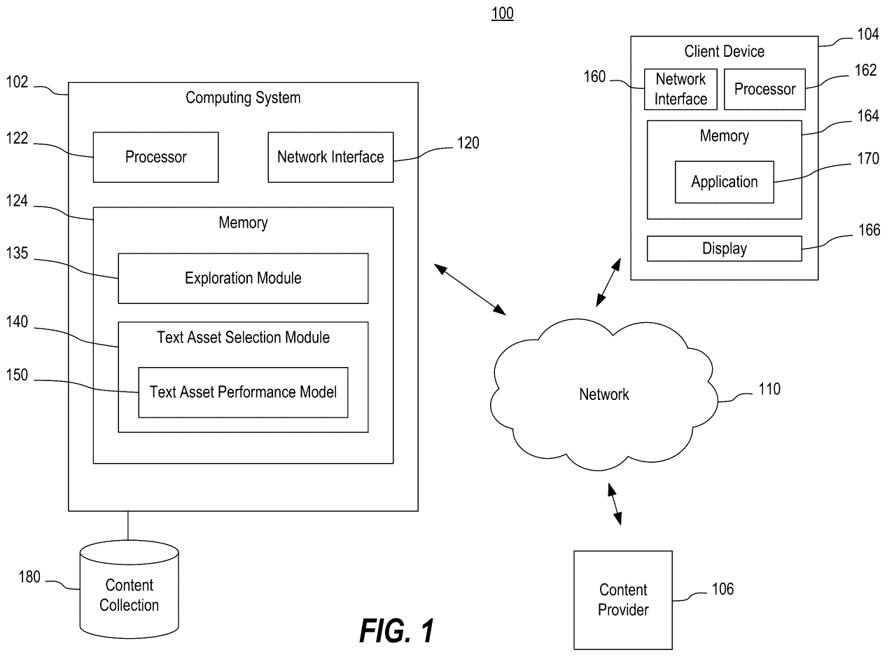

FIG. 1 is a block diagram of an example system 100 in which techniques for text asset selection can be implemented. The example system 100 includes a computing system 102, a client device 104, a content provider 106, a network 110, and a content collection 180. The computing system 102 is remote from the client device 104 and content provider 106, and is communicatively coupled to the client device 104 and content provider 106 via the network 110. In some implementations, the system 100 does not include client device 104 and/or content provider 106.

The network 110 may be a single communication network (e.g., the Internet), and in some implementations also includes one or more additional networks. As just one example, the network 110 may include a cellular network, the Internet, and a server-side local area network (LAN). While FIG. 1 shows only a single client device 104 and a single content provider 106, it is understood that the computing system 102 may also be in communication with a number (e.g., millions) of other client devices that are generally similar to the client device 104, and/or in communication with a number (e.g., thousands) of other content providers that are generally similar to content provider 106.

Generally, computing system 102 can improve text asset selection/matching for content items in a digital content collection (e.g., for providers such as content provider 106) by generating a text asset performance model based on real-world performance outcomes (e.g., impressions, click-throughs, conversions, etc.) for a sample of text asset and content item pairs from the digital content collection. While other contexts are also possible, for ease and consistency of explanation this disclosure primarily uses examples that are related to a digital advertising implementation/context. As mentioned above, the term “text-content pairs” is generally used herein to refer to pairings of content items (e.g., images or videos) and text assets (e.g., descriptions, headlines, etc.) from a digital content collection, such as content collection 180, and particular combinations of text assets and content items (i.e., particular text-content pairs) may illicit different interaction/responses from users (i.e., the performance of a content item may vary depending on which text asset is provided with the content item). The computing system 102 obtains performance outcomes for a sample/subset of text-content pairs from a digital content collection and uses the performance outcomes to generate a text asset performance model (e.g., a deep neural network or a Bayesian model) configured to predict the performance of text-content pairs. The computing system 102 can then use the generated text asset performance model to identify specific text-content pairs that are more likely to have superior real-world performance outcomes.

The client device 104 is generally configured to access information resources (e.g., user interfaces of mobile applications, or other applications, and/or user interfaces of web pages) that can present digital content such as the digital content (e.g., content items and/or text assets) from the content collection 180. For example, computing system 102 may generate digital advertisements that include (or consist entirely of) digital content items of the sort discussed herein (e.g., the digital content items of the content collection 180, and/or a text asset of the content collection 180 or a related datastore). Computing system 102 or another computing system may then serve the digital advertisements to users of client device 104 and/or other similar client devices using suitable techniques, such as conducting auctions (e.g., auctions based on keyword bids by advertisers, relevancy metrics, etc.). The digital advertisements may be served as in-video advertisements, in slots of web pages visited by the users, and/or slots of application user interfaces displayed to the users, etc.

For example, the computing system 102 may provide digital advertisements, that include (or consist entirely of) text-content pairs from content collection 180, to a content server (e.g., a media server, a web server, etc.). The content server may insert content items (e.g., video advertisements) and text assets (e.g., headlines, descriptions, etc.) at appropriate time slots and/or positions within media, web pages, or other content presented at client device 104. For instance, the content server may be a video/content streaming service such as YouTube.

The content provider 106 generally may commission or request that computing system 102 generate digital advertisements using the content items and/or text assets included in content collection 180. For example, content provider 106 may be a digital advertiser that provides one or more content items (e.g., digital advertisement videos) and corresponding text assets (e.g., descriptions, headlines, advertisement information, etc.) for each of a number of offered products or services, as part of one or more advertising campaigns owned or managed by content provider 106. In some implementations, the computing system 102 (or another computing system distinct from the content provider 106) generates some or all of the digital content items of content collection 180 (e.g., based on other content items and/or a list of desired features/characteristics provided by content provider 106).

The computing system 102 includes a network interface 120, a processor 122, and memory 124. The network interface 120 includes hardware, firmware, and/or software configured to enable the computing system 102 to exchange electronic data with the client device 104 and other, similar client devices (and possibly content provider 106, etc.) via the network 110. For example, the network interface 120 may include a wired or wireless router and a modem. The processor 122 may be a single processor (e.g., a central processing unit (CPU)), or may include multiple processors (e.g., multiple CPUs, or one or more CPUs and one or more graphics processing units (GPUs)). Computing system 102 may be a single computing device (e.g., server) at a single location, or may include multiple, coordinating computing devices that are either co-located or remotely distributed.

The memory 124 is a computer-readable, non-transitory storage unit or device, or collection of such units/devices, that may include persistent and/or non-persistent memory components. The memory 124 stores instructions executable by processor 122 to perform various operations, including the instructions of various software applications and the data generated and/or used by such applications. In the example system 100 of FIG. 1, memory 124 stores the instructions of an exploration module 135, a text asset selection module 140, and a text asset performance model 150, each of which can be executed by processor 122. More generally, it is understood that, in some implementations, memory 124 may omit one or more modules/elements shown in FIG. 1. It is also understood that, in some implementations, memory 124 may include one or more additional modules/elements not shown in FIG. 1, such as modules that facilitate serving videos and/or images (e.g., digital advertisements) to users of devices such as client device 104.

The client device 104 may be or include any stationary, mobile, or portable computing device with wired and/or wireless communication capability (e.g., a smartphone, a tablet computer, a laptop computer, a desktop computer, a smart wearable device such as smart glasses or a smart watch, a vehicle head unit computer, etc.). In the example implementation of FIG. 1, client device 104 includes a network interface 160, a processor 162, memory 164, and a display 166. The processor 162 may be a single processor, or may include multiple processors.

The memory 164 includes one or more computer-readable, non-transitory storage units or devices, which may include persistent and/or non-persistent memory components. The memory 164 stores instructions that are executable by processor 162 to perform various operations, including the instructions of various software applications and the data generated and/or used by such applications.

In the example system 100 of FIG. 1, memory 164 stores at least an application 170. Generally, application 170 is executed by processor 162 to provide one or more user interfaces via display 166, where the user interface(s) enable a user to access information resources that can include digital content items and text assets selected/provided by computing system 102. For example, application 170 may be a dedicated application (e.g., a mobile device software application or “mobile app”), and digital content items and/or text assets (text-content pairs) selected by computing system 102 may be included in content slots of user interfaces that are presented by the application 170 on display 166. Expanding on this example, the application 170 may be a video streaming application (also referred to herein as a “streaming application”) and text-content pairs selected by computing system 102 may be included in content periods of streamed videos (e.g., in-video content items or text assets), and/or in content slots of user interfaces (e.g., headlines, descriptions, and/or other text assets, provided with content items), presented by the application 170 on display 166. As another example, application 170 may be a web browser application, and text-content pairs selected by computing system 102 may be included in content slots of web pages visited by the user and presented on display 166. As a more specific example, the text-content pairs may be digital advertisements that are generated by computing system 102, and then selected and provided to client device 104 by computing system 102 (or by another computing system) for insertion in the content slots/periods.

The display 166 includes hardware, firmware, and/or software configured to enable a user to view visual outputs of the client device 104, and may use any suitable display technology (e.g., LED, OLED, LCD, etc.). In some implementations, the display 166 is incorporated in a touchscreen having both display and manual input capabilities. For example, in some implementations where the client device 104 is a wearable device, the display 166 is a transparent viewing component (e.g., lenses of smart glasses) with integrated electronic components. For example, the display 166 may include micro-LED or OLED electronics embedded in lenses of smart glasses.

The network interface 160 includes hardware, firmware, and/or software configured to enable the client device 104 to exchange electronic data with the computing system 102 via the network 110. For example, the network interface 160 may include a cellular communication transceiver, a WiFi transceiver, and/or transceivers for one or more other wired and/or wireless communication technologies.

While FIG. 1 shows client device 104 as a single component communicating directly (i.e., via network 110) with the computing system 102, in some implementations the subcomponents of client device 104 are instead divided among two or more user-side devices. As just one example, a pair of smart glasses may include the processor 162, the memory 164, and the display 166, while a smartphone may include another processing unit, another memory, another display, and the network interface 160. The smart glasses may then communicate as needed with the smartphone (e.g., via Bluetooth) to enable the operations described herein.

Returning to the computing system 102, the exploration module 135 generally operates by generating text asset performance model 150 (e.g., a probabilistic or Bayesian model, a machine learning model or deep neural network, a multi-task unified model, etc.) using text-content pairs from a content collection and/or associated with a content item group. In some embodiments, the text asset performance model 150 is a single model, while in other embodiments the text asset performance model 150 includes two or more component models. In some embodiments, the exploration module 135 generates a different model similar to text asset performance model 150 for each of a number of different content providers, content collections, and/or content item groups.

To generate the text asset performance model 150, the exploration module 135 may generate a plurality of sample text-content pairs using text assets and content items from a content collection, such as content collection 180. To this end, the exploration module 135 may first obtain a plurality of content items and/or a plurality of text assets from content collection 180. In various embodiments, for example, the exploration module 135 obtains all content items and/or all text assets in content collection 180, only content items and/or text assets associated with a particular content item group, only content items and/or text assets associated with particular performance metrics, or another suitable subset of content items and/or text assets of content collection 180. The exploration module 135 may then generate the sample text-content pairs (e.g., using the plurality of content items and the plurality of text assets) by selecting a subset of the possible combination of the obtained content items and text assets from content collection 180 (e.g., a random or stochastic sample of the possible combinations, a sample including a text-content pair for each content item and for each text asset, a percentage of the possible combinations, another suitable subset of the possible combinations). The exploration module 135 may then generate text asset performance model 150 based on performance outcomes for the sample text-content pairs.

In some embodiments, the exploration module 135 generates text asset performance model 150 as a probabilistic model that is configured to output predicted performance outcomes for input text-content pairs, based on performance outcomes for the sample text-content pairs from content collection 180. The performance outcomes for the sample text-content pairs may be indications of an event (e.g., an impression, a click-through, etc.). The exploration module 135 may calculate an initial probability of each text asset of the plurality of text assets (e.g., text assets obtained from content collection 180) being associated with such an event based on the performance outcomes for the sample text-content pairs. The exploration module 135 may also calculate an initial probability of each content item of the plurality of content items (e.g., content items obtained from content collection 180) being associated with such an event based on the performance outcomes for the sample text-content pairs. The exploration module 135 may then calculate a conditional probability of each text asset being associated with such an event in the context of specific content items, based on the performance outcomes for the sample text-content pairs. In some embodiments, the exploration module 135 may generate the probabilistic text asset performance model 150 using a Bayesian framework, or another suitable statistical framework/approach, and based on the initial probabilities (e.g., probability of a text asset being associated with an event, and probability of content item being associated with an event, etc.) and conditional probabilities for the sample text-content pairs.

In some embodiments, the exploration module 135 may generate initial probability distributions for text assets and content items relative to events, as well as conditional probability distributions for text assets in the context of particular content items. For example, using impression share as an objective function, suppose:

| | |
|---|---|
| P(C) | Probability of a certain Content Item Group being |
| | in an impression |
| P(T) | Probability of a certain Text Asset being in an impression |
| P(T\|C) | Probability of a Text Asset being part of an impression |
| | in which a certain Content Item Group is present |
| P(C\|T) | Probability of a Content Item Group being part of an |
| | impression in which a certain Text Asset is present |

Using a Bayesian framework, the exploration module 135 may compute P (T|C) for each text asset to which the text asset performance model 150 will be applied. In some embodiments, the exploration module 135 may generate the text asset performance model 150 using the computed probabilities as a weight for each respective text asset. Continuing with the above example, the probability of a content item group being part of an impression in which a certain text asset is present, or P (T|C), may be computed as:

| | |
|---|---|
| P(T\|C) | $\frac{P ( T ) * P ( C \vert T )}{P ( C )}$ |

Further, P (T|C) may be reduced to the following operations:

| | |
|---|---|
| P(T) | $\frac{Impression with {T}_{n}}{Total number of impressions}$ |
| P(C) | $\frac{Impression with {C}_{x}}{Total number of impressions}$ |
| P(C\|T) | $\frac{Impression of {C}_{x} wih Tn}{Total impressions of {T}_{n}}$ |

Using these operations, P (T|C) may be computed as:

| | |
|---|---|
| P(T\|C) | $\frac{\frac{Impression with {T}_{n}}{Total number of impressions} \times \frac{Impression of {C}_{x} with {T}_{n}}{Total impressions of {T}_{n}}}{\frac{Impression with {C}_{x}}{Total number of impressions}}$ |
| P(T\|C) | $\frac{Impression with {T}_{n}}{Total number of impressions} \times \frac{Impression of {C}_{x} with {T}_{n}}{Total impressions of {T}_{n}} \times \frac{Total number of impressions}{Impression with {C}_{x}}$ |
| P(T\|C) | $\frac{Impression of {C}_{x} with {T}_{n}}{Impression with {C}_{x}}$ |

Said another way, P (T|C) may be computed as the quotient of the impressions of a particular content item group with a particular text asset and the impressions with the particular content item group. As mentioned above, P (T|C) may be computed for various groupings of text assets and/or content items included in a content collection, such as content collection 180.

In an example implementation, where the exploration module 135 generates the probabilistic text asset performance model 150, each content item of the plurality of content items obtained by exploration module 135 is included in at least one text-content pair of the plurality of sample text-content pairs and each text asset of the plurality of text assets obtained by exploration module 135 is included in at least one text-content pair of the plurality of sample text-content pairs. Furthermore, each content item and each text asset, from which the exploration module 135 may select one or more preferred text-content pairs, is processed and/or evaluated (e.g., by the exploration module 135) when generating the probabilistic text asset performance model 150, thereby ensuring that the probabilistic text asset performance model 150 is representative of each possible text asset and each possible content item. Advantageously, by processing/evaluating each text asset and content item when generating probabilistic model 150, an example system can avoid the issues associated with applying conventional probabilistic models to unseen data (e.g., overfitting, underfitting, generalization errors, etc.).

In some embodiments, the exploration module 135 generates the text asset performance model 150 as a machine learning (ML) model trained to output predicted performance outcomes for input text-content pairs. Generally, in these embodiments, the text asset performance model 150 may include a deep neural network (e.g., a convolutional neural network) and/or one or more other machine learning models suitable for image and/or text processing. In some embodiments, the exploration module 135 may train the text asset performance model 150 using a plurality of sample text-content pairs from content collection 180 and the performance outcomes for the plurality of sample text-content pairs. For example, such a plurality of sample text-content pairs may include: random text-content pairs from a digital content collection, text-content pairs for content items and/or text assets above a certain performance threshold, at least one respective text-content pair for each content item/text asset of a digital content collection (e.g., in a probabilistic implementation of the text asset performance model), etc. As mentioned above, the text asset performance model 150 may be and/or include a deep neural network (DNN).

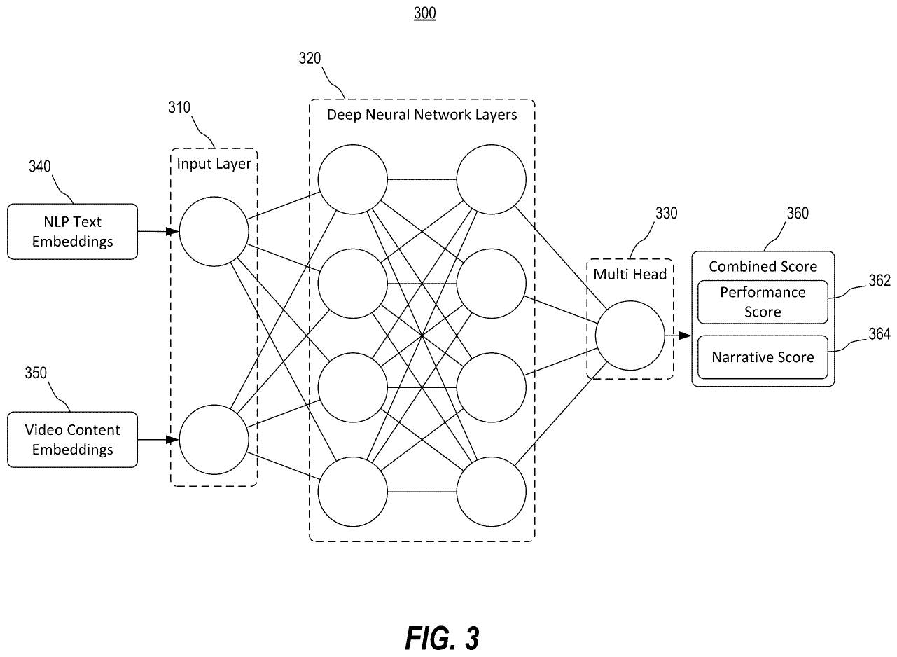

In some embodiments, the exploration module 135 trains the DNN text asset performance model 150 using the sample text-content pairs generated by exploration module 135 and performance outcomes for the sample text-content pairs. For example, the exploration module 135 may train the DNN text asset performance model 150 on sample text-content pairs labeled with corresponding performance outcomes, thereby teaching the DNN to predict performance outcomes for a given text-content pair. In some embodiments, the text asset performance model 150 (e.g., a deep neural network, a convolutional neural network, etc.) includes a multi-head attention mechanism/layer trained to output both performance outcomes and narrative quality metrics, as described below with respect to FIG. 3. In some such embodiments, the exploration module 135 trains the DNN text asset performance model 150 that includes a multi-head attention layer on text-content pairs labeled with (i) event outcomes (e.g., impressions, click-throughs, etc.) and (ii) narrative quality scores (e.g., generated by human reviewers and/or one or more generative AI models). Narrative quality scores may be based on relatively subjective factors such as narrative consistency, context, level of detail, appropriateness, etc., with respect to how well a given text asset pairs with a given content item.

To automate the development of narrative quality score labels for training the text asset selection model 150, memory 124 may store one or more generative artificial intelligence (AI) models that evaluate text-content pairs of a content collection. In some such embodiments, the text asset performance module 140 generates one or more scores for a text-content pair by inputting one or more prompts, including set(s) of instructions, and text-content pairs to the generative AI model. In some implementations, a generative AI model is not included in system 100. For example, the generative AI model may be stored in one or more remote servers or other computing systems. Further, the generative AI model utilized by computing system 102 may be remotely accessed (e.g., as a cloud service) by the text asset performance module 140 to obtain evaluation data (e.g., scores or grades) for text-content pairs from content collection 180.

In some embodiments, the exploration module 135 generates the text asset selection model 150 as a multi-task unified model (MUM) trained to output predicted performance outcomes for input text-content pairs. A multi-task unified model may be a language model trained on high-quality web data and/or rich media (e.g., images, videos) to develop a strong understanding of various content, languages, and other media. In some embodiments, the exploration module 135 may finetune a multi-task unified model on text-content pairs associated with high performance. For example, the exploration module 135 may train a multi-task unified model on text-content pairs of a content collection associated with an above average performance metric (e.g., conversion rate, impression rate, etc.), an evaluation score from a human reviewer or machine learning model, and/or one or more other performance indicators. Generally, the text asset selection module 140 may identify the best text asset for a given content item of a content collection using such a finetuned multi-task unified model.

The text asset selection module 140 generally operates by using the text asset selection model 150 generated by the exploration module 135 (e.g., a probabilistic or Bayesian model, a ML model, a multi-task unified model, etc., as described above) to predict performance outcomes, and by using these performance outcomes to determine preferred text-content pairs from among a set of potential/candidate text-content pairs. The text asset selection module 140 may identify preferred text assets for particular content items to be served in real-time, or may operate as an offline/backend process to identify preferred pairings, for example. In some embodiments, the text asset selection module 140 evaluates text-content pairs associated with a particular content item group of a content collection (e.g., content items and text assets related to a particular category or concept, such as shoes, clothing, electronics, etc.).

The content collection 180 may be a digital content collection database/datastore, and may store a plurality of digital content items (e.g., with each digital content item discussed herein being a video, frames of a video, an image, etc.) and/or text assets (e.g., text descriptions, headlines, metadata, etc.) of a content provider such as content provider 106. For example, the content items in the content collection 180 may correspond to an advertising campaign owned or managed by content provider 106. In some embodiments, the text assets described herein (e.g., text assets corresponding to content items of the content collection 180) may be stored in a separate datastore not depicted in FIG. 1, such as an electronic database, cloud-based datastore, a vector store, etc. For example, vector representations of the text assets (e.g., text embeddings) may be stored in a vector/embedding database.

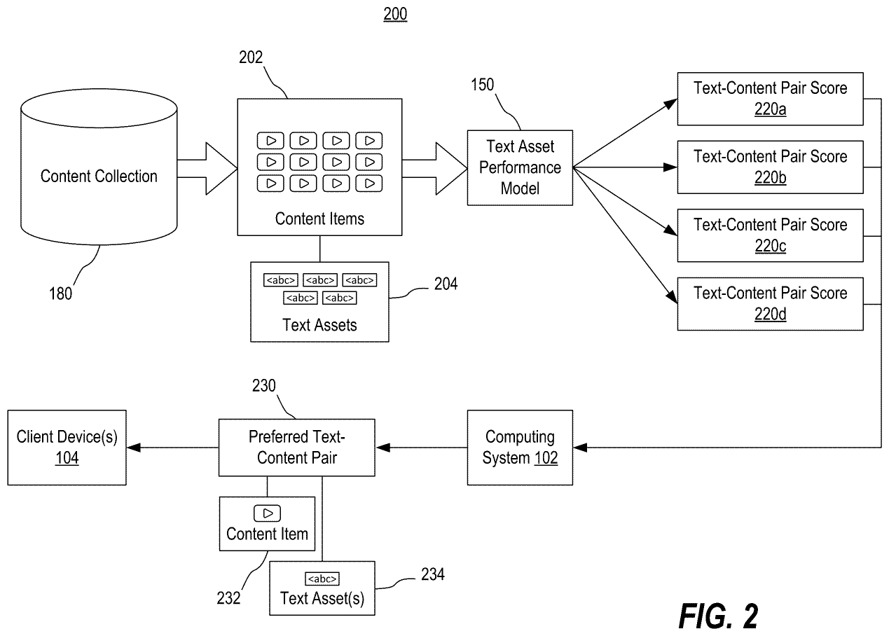

FIG. 2 is a block diagram of a text asset selection process 200 for content items in a content collection. The process 200 may be implemented by the computing system 102 (e.g., via the exploration module 135 and/or the text asset selection module 140) of FIG. 1, for example. FIG. 2 depicts an example of text asset and content item pair (text-content pair) analysis for a content collection (in the depicted example, content collection 180 of FIG. 1) for the purposes of identifying preferred text-content pairs of a content collection. The process 200 may occur using text asset performance model 150 of FIG. 1, e.g., after the text asset performance model 150 is generated by exploration module 135 based on sample text-content pairs from content collection 180.

The text asset selection process 200 includes analyzing various text-content pairs of content collection 180 using the text asset performance model 150 (e.g., a machine learning model), to thereby generate various text-content pair scores (e.g., scores 220a-220d). For example, the exploration module 135 may obtain a plurality of content items 202 and/or a plurality of text assets 204 from content collection 180. The text asset selection module 140 may then apply the text asset performance model 150 to text-content pairs corresponding to different combinations of the content items 202 and the text assets 204. In some embodiments, the generated text-content pairs include only text-content pairs that were not used to train and/or generate text asset performance model 150.

Based on the text-content pair scores 220a-220d, the text asset selection module 140 may identify a preferred text-content pair 230 (content item 232 and one of text assets 234). For example, the text asset selection module 140 may select the text-content pair 230 having the highest score. Additionally, the text asset selection process 200 may include providing the preferred text-content pair 230 to one or more client devices (client device 104 and possibly one or more other similar devices). The process 200 may include providing the text-content pair 230 as a digital advertisement to client device(s) 204, as described with respect to FIG. 1, for example.

In some embodiments, the text asset selection module 140 identifies one or more preferred text assets (e.g., text assets 234) for a particular content item (e.g., content item 232) of content collection 180, and the process 200 includes providing the content item and at least one preferred text asset to one or more client devices 104. For example, a particular content item of content collection 180 may be selected (e.g., by computing system 102, another computing system, content provider 106, etc.) for serving to a user device, such as client device 104, and the text asset selection module 140 may identify (e.g., in real time) a preferred text asset for the selected content item by scoring different text assets in combination with that particular content item. In some embodiments, the process 200 is implemented as an offline, backend process in which the text asset selection module 140 identifies preferred text assets for each of multiple content items (e.g., all content items) of content collection 180. Metadata indicating the associations of the preferred text-content pairs for the content items may then be stored (e.g., by computing system 102, in content collection 180 or another datastore of the computing system 102), thereby eliminating the need to use the text asset selection model 150 to determine preferred text assets for a selected content item at runtime.

FIG. 3 is a block diagram of an example deep neural network (DNN) 300 for improved text asset selection for content items in a content collection (e.g., content collection 180 of FIG. 1). The deep neural network 300 may be the text asset performance model 150 of FIG. 1, for example.

The example DNN 300 includes an input layer 310, deep neural network layers 320, and a multi-head attention layer 330. Generally, the input layer 310 may include a first node configured to accept/receive textual embeddings 340 (e.g., a text asset embedding) and a second node configured to accept/receive content embeddings 350 (e.g., a video or image embedding). In some embodiments, the text asset selection module 140 may generate textual embeddings 340 using a natural language processing (NLP) model (e.g., in a preprocessing step) and/or an NLP layer (e.g., a text embedding layer included in DNN 300). Additionally or alternatively, the text asset selection module 140 may generate content embeddings 350 (e.g., video or image embeddings) using an embedding model (e.g., in a preprocessing step) and/or an embedding layer (e.g., a content embedding layer included in DNN 300). The deep neural network layers 320 may include two or more fully connected layers, or dense layers. Typically, each node, or neuron, in a fully connected layer is connected to each node in the preceding and succeeding layer, thereby enabling the DNN 300 to learn complex patterns/relationships. The multi-head attention layer 330 may include two or more attention mechanisms respectively trained/configured to focus to the DNN 300 on particular aspects of the input data.

Generally, the exploration module 135 may train the DNN 300 on performance outcomes for a plurality of sample text-content pairs from a content collection, such as content collection 180 of FIG. 1, in conjunction with respective labels for the text-content pairs. The labels may include labels indicative of actual performance and/or labels indicative of human or machine/model scoring of the samples. In some embodiments, for example, the exploration module 135 trains the DNN 300 on one or more performance metrics (e.g., eCPM, impression rate, conversion rate, etc.) for the sample text-content pairs, as determined by monitoring actual performance of the sample text-content pairs, or based on other scores derived from the performance metric(s). In some embodiments, the exploration module 135 may also or instead train the DNN 300 on more subjective, narrative quality labels and/or human evaluation scores for the sample text-content pairs. In some embodiments, the DNN 300 includes the multi-head attention layer 330, and the exploration module 135 trains the DNN 300 to generate multiple scores for a given text-content pair. For example, the exploration module 135 may train a first attention mechanism of the multi-head attention layer 330 on text-content pairs labeled with respective performance metrics/values (e.g., effective cost per mille (eCPM) scores/indications), and also train a second attention mechanism of the multi-head attention layer 330 on text-content pairs labeled with respective narrative evaluation scores. In some embodiments, human reviewers may evaluate text-content pairs of a content collection and to generate the evaluation scores used as labels, based on various indicators such as narrative consistency, context, level of detail, appropriateness, etc. Additionally or alternatively, a generative AI model (e.g., implemented by the text asset selection module 140 or a different module, device, or system) may generate narrative quality scores for use as text-content pair labels, e.g., by inputting a prompt that includes a set of instructions and the text content pair to the generative AI model (e.g., a large language model or a generative transformer model). An example prompt may include:

You are a YouTube video content optimization expert specializing in selecting
the most effective headline and description pairings for YouTube video
advertisements. Your task is to analyze a provided list of headline and
description options and select the single best pair for a given YouTube video
URL, considering the video's likely subject matter inferred from the URL and
the provided text. You will have direct access to the video content itself.
Prioritize accuracy, relevance, narrative coherence, and the ability of the
headline and description to ″sell the click″ with a strong value proposition and
call to action. Your output should consist only of the selected headline, the
selected description, and a concise explanation justifying your choice,
including a brief summary of the video's inferred topic. Consider the provided
guidelines on effective video ad creation, focusing on complementary
storytelling, enhanced accessibility and engagement, strategic emphasis, and
brand consistency. Base your assessment on the provided examples of
effective ad combinations.
Step by Step Instructions
Access the provided youtube_url ({youtube_url}).
Parse the HeadlineText string into a list of headlines, splitting at each
semicolon (;).
Parse the DescriptionText string into a list of descriptions, splitting at each
semicolon (;).
Initialize an empty dictionary to store scores for each headline-description
pair. The keys will be tuples (headline, description), and the values will be
their scores (e.g., 1-5, where 5 is the best fit).
Iterate through the lists of headlines and descriptions using zip to maintain
alignment.
For each (headline, description) pair:
Analyze the youtube_url to further refine the inferred video topic.
Evaluate how well the headline and description align with the inferred topic.
Consider keywords, general subject matter, narrative coherence, and the
ability to ″sell the click″ (strong value proposition and call to action).
Assign a score (1-5) based on relevance, accuracy, narrative coherence, and
the guidelines provided in the additional context (e.g., ″Better narrative
means...″, ″What makes a good ad?″).
Store the score in the dictionary using the (headline, description) pair as the
key.
After iterating through all pairs, find the key (headline, description) with the
highest score in the dictionary.
Output the headline and description corresponding to the highest score. If
multiple pairs share the highest score, output one arbitrarily.
Provide a brief explanation of your reasoning, referencing the youtube_url, the
selected headline and description, and the scoring criteria used. Also explain
why other headline and descriptions were not selected. Include a summary of
the video's inferred topic.
Headline Text:
{headline_text}
Description Text:
{description_text}
Url:
{youtube_url}
Please provide your response in the following JSON format. Also the output
should be parsable by json parsers. Do not use ‘‘‘json prefix or ‘‘‘ as suffix in
the final output.
Output: {{ ′youtube_url′: ′youtube_url′, ′headline′: ′selected_headline′,
′description′: ′selected_description′, ′reasoning′: ′your_reasoning_here′ }}
′′′

In operation, the text asset selection module 140 may generate a combined score 360 for a given text-content pair (i.e., a given text asset and content item) by providing the text-content pair, and/or respective text and content embeddings, to the trained DNN 300. In the multi-head example shown, the combined score 360 includes a performance score 362 and a narrative score 364 for the input text-content pair. As described above with respect to FIGS. 1-2, the text asset selection module 140 may identify preferred text-content pairs from content collection 180 using DNN 300, based on the respective scores (e.g., 360, 362, 364) for each text-content pair. For example, the text asset selection module 140 may determine a text-content pair by selecting the highest scoring text asset for a particular content item, and associate that text asset with that content item.

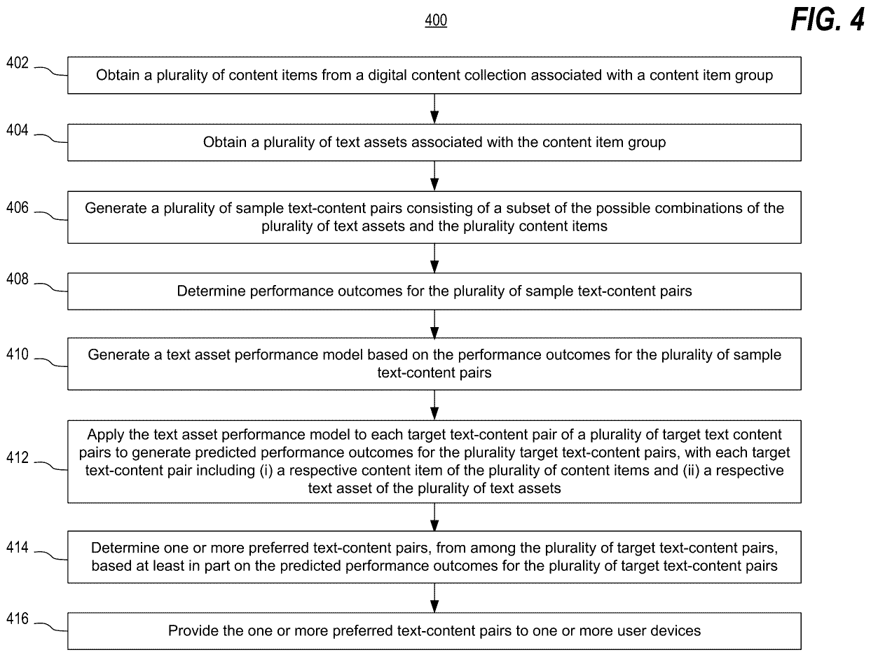

FIG. 4 is a flow diagram of an example method 400 for text asset selection. The method 400 may be implemented by the computing system 102 (e.g., by the exploration module 135 and/or the text asset selection module 140) of FIG. 1, for example.

At block 402, a plurality of content items associated with a content item group are obtained from a digital content collection (e.g., content collection 180 of FIG. 1).

At block 404, a plurality of text assets associated with the content item group are obtained (e.g., also from content collection 180).

At block 406, a plurality of sample text-content pairs consisting of a subset of the possible combinations of the plurality of text assets and the plurality content items are generated.

At block 408, performance outcomes for the plurality of sample text-content pairs are determined.

At block 410, a text asset performance model is generated based on the performance outcomes for the plurality of sample text-content pairs. In some embodiments, the text asset performance model includes a deep neural network (DNN), a probabilistic model, and/or a multi-task unified model (MUM).

As mentioned above, in some embodiments, the text asset performance model may include a DNN (e.g., DNN 300 of FIG. 3). Additionally, the method may include generating the text asset performance model by training a DNN using the plurality of sample text-content pairs and the performance outcomes for the plurality of sample text-content pairs. In some embodiments, the DNN includes a multi-head attention layer trained to output both performance outcomes and narrative quality metrics. The method 400 may further include generating narrative quality metric labels for the plurality of sample text-content pairs using a generative AI model. Additionally or alternatively, the method 400 may include training the DNN using the plurality of sample text-content pairs, the narrative quality metric labels for the plurality of sample text-content pairs, and the performance outcomes for the plurality of sample text-content pairs.

As was also mentioned above, in some embodiments, the text asset performance model may include a probabilistic model (e.g., a Bayesian model). Further, the performance outcomes may be indications of an event, each content item of the plurality of content items may be included in at least one text-content pair of the plurality of sample text-content pairs, and each text asset of the plurality of text assets may be included in at least one text-content pair of the plurality of sample text-content pairs. The method 400 may include generating the text asset performance model by generating, based at least in part on the performance outcomes for the plurality of sample text-content pairs, (i) first probabilities of the plurality of text assets having the event, (ii) second probabilities of the plurality of content items having the event, and (iii) conditional probabilities of the plurality of content items having the event with respect to particular text assets of the plurality of text assets. Additionally or alternatively, the method 400 may include generating the probabilistic model based at least in part on a Bayesian formula, the first probabilities, the second probabilities, and the conditional probabilities. In some embodiments, the event is (i) a content item impression or (ii) a content item selection by a user.

Other model types are also possible (e.g., a MUM).

At block 412, the text asset performance model is applied to each target text-content pair of a plurality of target text content pairs to generate predicted performance outcomes for the plurality target text-content pairs. For instance, each target text-content pair may include (i) a respective content item of the plurality of content items and (ii) a respective text asset of the plurality of text assets.

At block 414, one or more preferred text-content pairs are determined, from among the plurality of target text-content pairs and based at least in part on the predicted performance outcomes for the plurality of target text-content pairs.

At block 416, the one or more preferred text-content pairs are provided to one or more user devices. As described with respect to FIG. 1, in some embodiments, a computing system (e.g., computing system 102) may serve text-content pairs (e.g., preferred pairs) to users of client device(s) 104. In other embodiments, the computing system 102 may provide text-content pairs to a content server (e.g., a media server such as YouTube®, a web server, etc.), which in turn serves the text-content pairs (e.g., as video advertisements) to users of client device(s) 104.

It is understood that the blocks of FIG. 4 need not be performed strictly in the order shown. For example, block 404 may be performed in parallel with block 402.

As is apparent from the above description, techniques disclosed herein use artificial intelligence to process various modes of input data. Artificial intelligence (AI) is a segment of computer science that focuses on the creation of models that can perform tasks with little to no human intervention. Artificial intelligence systems can utilize, for example, machine learning, natural language processing, and computer vision. Machine learning, and its subsets, such as deep learning, focus on developing models that can infer outputs from data. The outputs can include, for example, predictions and/or classifications. Natural language processing focuses on analyzing and generating human language. Computer vision focuses on analyzing and interpreting images and videos. Artificial intelligence systems can include generative models that generate new content, such as images, videos, text, audio, and/or other content, in response to input prompts and/or based on other information.

Example machine-learned models include neural networks or other multi-layer non-linear models. Example neural networks include deep neural networks, feed forward neural networks, recurrent neural networks, and convolutional neural networks. Some example machine-learned models can leverage an attention mechanism such as multi-head attention and/or other self-attention mechanisms. For example, some machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts) can be used to improve the generalization capability of the models being trained.

The model(s) can be pre-trained before domain-specific alignment. For instance, a model can be pretrained over a general corpus of training data and finetuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data, and may be further updated or refined during their use based on additional feedback/inputs.

In some implementations, the computing system 102 uses one or more of the machine learning models or techniques noted above to perform any one or more of the operations discussed herein in connection with machine learning. For example, the computing system 102 may use one or more such machine learning techniques to pre-train and/or finetune the machine learning model 150, and possibly to pre-train and/or finetune a model that predicts performance of a text asset, etc.

Although the foregoing text sets forth a detailed description of numerous different aspects and implementations of the invention, it should be understood that the scope of the patent is defined by the words of the claims set forth at the end of this patent. The detailed description is to be construed as exemplary only and does not describe every possible implementation because describing every possible implementation would be impractical, if not impossible. Numerous alternative implementations could be implemented, using either current technology or technology developed after the filing date of this patent, which would still fall within the scope of the claims.

The following additional considerations apply to the foregoing discussion and the appended claims. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first set of one or more processors (e.g., in a first computing device) generates X and a distinct, second set of one or more processors (e.g., in a different, second computing device) independently generates Y; (2) implementations in which all processors in the set of one or more processors (e.g., all in the same device, or distributed among multiple devices) contribute to the generation of both X and Y; and (3) other variations.

Unless specifically stated otherwise, discussions in the present disclosure using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used in the present disclosure any reference to “one implementation” or “an implementation” means that a particular element, feature, structure, or characteristic described in connection with the implementation is included in at least one implementation. The appearances of the phrase “in one implementation” in various places in the specification are not necessarily all referring to the same implementation.

As used in the present disclosure, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs through the principles described herein. Thus, while particular implementations and applications have been illustrated and described, it is to be understood that the disclosed implementations are not limited to the precise construction and components disclosed in the present disclosure. Various modifications, changes and variations, which will be apparent to those skilled in the art, may be made in the arrangement, operation and details of the method and apparatus disclosed in the present disclosure without departing from the spirit and scope defined in the appended claims.

What is claimed is:

1. A method for text asset selection, the method comprising:
obtaining, by one or more processors, a plurality of content items from a digital content collection associated with a content item group;
obtaining, by the one or more processors, a plurality of text assets associated with the content item group;
generating, by the one or more processors, a plurality of sample text-content pairs consisting of a subset of the possible combinations of the plurality of text assets and the plurality content items;
determining, by the one or more processors, performance outcomes for the plurality of sample text-content pairs;
generating, by the one or more processors, a text asset performance model based on the performance outcomes for the plurality of sample text-content pairs;
applying, by the one or more processors, the text asset performance model to each target text-content pair of a plurality of target text content pairs to generate predicted performance outcomes for the plurality target text-content pairs, with each target text-content pair including (i) a respective content item of the plurality of content items and (ii) a respective text asset of the plurality of text assets;
determining, by the one or more processors, one or more preferred text-content pairs, from among the plurality of target text-content pairs, based at least in part on the predicted performance outcomes for the plurality of target text-content pairs; and
providing, by the one or more processors, the one or more preferred text-content pairs to one or more user devices.

2. The method of claim 1, wherein the text asset performance model includes a deep neural network (DNN), and wherein generating the text asset performance model comprises:
training the DNN using the plurality of sample text-content pairs and the performance outcomes for the plurality of sample text-content pairs.

3. The method of claim 2, wherein the DNN includes a multi-head attention layer trained to output both performance outcomes and narrative quality metrics.

4. The method of claim 3, further comprising:
generating, by the one or more processors and using a generative AI model, narrative quality metric labels for the plurality of sample text-content pairs; and
training, by the one or more processors, the DNN using the plurality of sample text-content pairs, the narrative quality metric labels for the plurality of sample text-content pairs, and the performance outcomes for the plurality of sample text-content pairs.

5. The method of claim 1, wherein the text asset performance model includes a probabilistic model, wherein the performance outcomes are indications of an event, wherein each content item of the plurality of content items is included in at least one text-content pair of the plurality of sample text-content pairs, wherein each text asset of the plurality of text assets is included in at least one text-content pair of the plurality of sample text-content pairs, and wherein generating the text asset performance model comprises:
generating, based at least in part on the performance outcomes for the plurality of sample text-content pairs, (i) first probabilities of the plurality of text assets having the event, (ii) second probabilities of the plurality of content items having the event, and (iii) conditional probabilities of the plurality of content items having the event with respect to particular text assets of the plurality of text assets; and
generating the probabilistic model based at least in part on a Bayesian formula, the first probabilities, the second probabilities, and the conditional probabilities.

6. The method of claim 5, wherein the event is (i) a content item impression or (ii) a content item selection by a user.

7. The method of claim 1, wherein the text asset performance model includes a multi-task unified model (MUM).

8. A computing system for text asset selection, the computing system comprising:
one or more processors; and
one or more non-transitory memories having stored thereon computer-executable instructions that, when executed by the one or more processors, cause the computing system to:
obtain a plurality of content items from a digital content collection associated with a content item group;
obtain a plurality of text assets associated with the content item group;
generate a plurality of sample text-content pairs consisting of a subset of the possible combinations of the plurality of text assets and the plurality content items;
determine performance outcomes for the plurality of sample text-content pairs;
generate a text asset performance model based on the performance outcomes for the plurality of sample text-content pairs;
apply the text asset performance model to each target text-content pair of a plurality of target text content pairs to generate predicted performance outcomes for the plurality target text-content pairs, with each target text-content pair including (i) a respective content item of the plurality of content items and (ii) a respective text asset of the plurality of text assets;
determine one or more preferred text-content pairs, from among the plurality of target text-content pairs, based at least in part on the predicted performance outcomes for the plurality of target text-content pairs; and
provide the one or more preferred text-content pairs to one or more user devices.

9. The computing system of claim 8, wherein the text asset performance model includes a deep neural network (DNN), and
the one or more non-transitory memories having stored thereon computer executable instructions that, when executed by the one or more processors, generate the text asset performance model by causing the computing system to:
train the DNN using the plurality of sample text-content pairs and the performance outcomes for the plurality of sample text-content pairs.

10. The computing system of claim 9, wherein the DNN includes a multi-head attention layer trained to output both performance outcomes and narrative quality metrics.

11. The computing system of claim 10, the one or more non-transitory memories having stored thereon computer executable instructions that, when executed by the one or more processors, cause the computing system to:
generate, using a generative AI model, narrative quality metric labels for the plurality of sample text-content pairs; and
train the DNN using the plurality of sample text-content pairs, the narrative quality metric labels for the plurality of sample text-content pairs, and the performance outcomes for the plurality of sample text-content pairs.

12. The computing system of claim 8, wherein the text asset performance model includes a probabilistic model, wherein the performance outcomes are indications of an event, wherein each content item of the plurality of content items is included in at least one text-content pair of the plurality of sample text-content pairs, wherein each text asset of the plurality of text assets is included in at least one text-content pair of the plurality of sample text-content pairs, and
the one or more non-transitory memories having stored thereon computer executable instructions that, when executed by the one or more processors, generate the text asset performance model by causing the computing system to:
generate, based at least in part on the performance outcomes for the plurality of sample text-content pairs, (i) first probabilities of the plurality of text assets having the event, (ii) second probabilities of the plurality of content items having the event, and (iii) conditional probabilities of the plurality of content items having the event with respect to particular text assets of the plurality of text assets; and
generate the probabilistic model based at least in part on a Bayesian formula, the first probabilities, the second probabilities, and the conditional probabilities.

13. The computing system of claim 12, wherein the event is (i) a content item impression or (ii) a content item selection by a user.

14. The computing system of claim 8, wherein the text asset performance model includes a multi-task unified model (MUM).

15. A tangible, non-transitory computer-readable medium storing processor-executable instructions that, when executed by one or more processors of a computing system, cause the computing system to:
obtain a plurality of content items from a digital content collection associated with a content item group;
obtain a plurality of text assets associated with the content item group;
generate a plurality of sample text-content pairs consisting of a subset of the possible combinations of the plurality of text assets and the plurality content items;
determine performance outcomes for the plurality of sample text-content pairs;
generate a text asset performance model based on the performance outcomes for the plurality of sample text-content pairs;
apply the text asset performance model to each target text-content pair of a plurality of target text content pairs to generate predicted performance outcomes for the plurality target text-content pairs, with each target text-content pair including (i) a respective content item of the plurality of content items and (ii) a respective text asset of the plurality of text assets;
determine one or more preferred text-content pairs, from among the plurality of target text-content pairs, based at least in part on the predicted performance outcomes for the plurality of target text-content pairs; and
provide the one or more preferred text-content pairs to one or more user devices.

16. The computer-readable medium of claim 15, wherein the text asset performance model includes a deep neural network (DNN), and
wherein the processor-executable instructions, when executed, generate the text asset performance model by further causing the computing system to:
train the DNN using the plurality of sample text-content pairs and the performance outcomes for the plurality of sample text-content pairs.

17. The computer-readable medium of claim 16, wherein the DNN includes a multi-head attention layer trained to output both performance outcomes and narrative quality metrics.

18. The computer-readable medium of claim 17, wherein the processor-executable instructions, when executed, further cause the system to:
generate, using a generative AI model, narrative quality metric labels for the plurality of sample text-content pairs; and
train the DNN using the plurality of sample text-content pairs, the narrative quality metric labels for the plurality of sample text-content pairs, and the performance outcomes for the plurality of sample text-content pairs.

19. The computer-readable medium of claim 15, wherein the text asset performance model includes a probabilistic model, wherein the performance outcomes are indications of an event, wherein each content item of the plurality of content items is included in at least one text-content pair of the plurality of sample text-content pairs, wherein each text asset of the plurality of text assets is included in at least one text-content pair of the plurality of sample text-content pairs, and
wherein the processor-executable instructions, when executed, generate the text asset performance model by further causing the computing system to:
generate, based at least in part on the performance outcomes for the plurality of sample text-content pairs, (i) first probabilities of the plurality of text assets having the event, (ii) second probabilities of the plurality of content items having the event, and (iii) conditional probabilities of the plurality of content items having the event with respect to particular text assets of the plurality of text assets; and
generate the probabilistic model based at least in part on a Bayesian formula, the first probabilities, the second probabilities, and the conditional probabilities.

20. The computer-readable medium of claim 19, wherein the event is (i) a content item impression or (ii) a content item selection by a user.
